(19) United States
(12) Patent Application Publication
(10) Pub. No.: US 2019/0228168 A1
(43) Pub. Date: Jul. 25, 2019

(54) SECURE ACCESS TO CONNECTED VEHICLE PERIPHERALS

(71) Applicant: GM GLOBAL TECHNOLOGY OPERATIONS LLC, Detroit, MI (US)

(72) Inventors: Aditya S. Kamini, Bloomfield Hills, MI (US); Liza Baby, Novi, MI (US)

(21) Appl. No.: 15/875,879

(22) Filed: Jan. 19, 2018

(51) Int. Cl. G06F 21/62; H04L 29/06

(52) U.S. Cl. CPC G06F 21/629; H04L 63/105; H04L 63/108

(57) ABSTRACT

Methods and systems for providing access to a vehicle by a peripheral device are disclosed. An example method includes receiving a peripheral device access request from a primary device for a vehicle application. The primary device may be configured to access a plurality of features of the vehicle application. The method may further include generating a token for the peripheral device in response to the peripheral device access request, with the token including at least an identifier and an access level indicator for the peripheral device. The access level indicator may include only a subset of the plurality of features of the vehicle application.

### INTRODUCTION

The present invention relates to systems and methods for accessing vehicle application functions with a mobile device, and more particularly, with a wearable mobile device.

As tablet and smartphone devices have become more advanced and capable of replacing computers, they have also become somewhat larger and/or bulkier. Accordingly, peripheral devices have been developed which are smaller, and may in some cases be wearable, e.g., as a wristwatch. These peripheral or wearable devices generally pair with a tablet, smartphone, or other computing device to facilitate their use while on the go, such as by displaying notifications, and in some cases allowing limited use of smartphone/computer functions, e.g., to send communications via voice command, menu selections, or the like.

Peripheral or wearable devices generally have smaller screens or more limited user interfaces as a result of their generally smaller size, thereby limiting their functionality as compared with an associated computer or smartphone. As a result, it may be more difficult to authenticate or otherwise provide security measures via the peripheral device in the absence of the associated computer or smartphone. Accordingly, users of wearable or peripheral devices may need to use their associated master device (i.e., the computer or smartphone) to access applications requiring passwords or other security measures, or at least have the master device present. These limitations are particularly acute in a vehicle environment, where an increasing number of vehicle applications allow for access to vehicle commands using a computer or smartphones. For example, users may have their computer/smartphone device packed away or otherwise be encouraged not to use these devices during vehicle operation.

Accordingly, there is a need for an improved method of allowing access by a peripheral device to vehicle applications or commands.

### SUMMARY

In at least some example implementations, a method of providing access to a peripheral device includes receiving a peripheral device access request from a primary device for a vehicle application. The primary device may be configured to access a plurality of features of the vehicle application. The method may further include generating a token for the peripheral device in response to the peripheral device access request, with the token including at least an identifier and an access level indicator for the peripheral device. The access level indicator may include only a subset of the plurality of features of the vehicle application.

In another example, a method further includes receiving an access request from the peripheral device, and selectively permitting the peripheral device to access the subset of the plurality of features of the vehicle application based upon a comparison of the identifier with an identity of the peripheral device. In these examples, access by the peripheral device may be denied unless the identity of the peripheral device matches the identifier and a token input matching the format indicator is received.

In at least some examples, a token format indicator includes one of an alphabetic indicator, a numeric indicator, alpha-numeric indicator, and a voice command indicator.

In another example illustration, the token includes a defined duration. In some of these examples, a method may further include selectively permitting the peripheral device to access the subset of the plurality of features of the vehicle application based upon the defined duration. For examples, access by the peripheral device may be restricted after an expiration of the defined duration.

In at least some examples, a system for accessing a vehicle function with a peripheral device, includes a server providing an application configured to be stored on a mobile device. The application may be configured to receive a peripheral device access request from a primary device for a vehicle application. The primary device may be configured to access a plurality of features of the vehicle application. The system may additionally include a telematics unit installed to a vehicle, which is configured to receive a token for the peripheral device at the vehicle. The token may include at least an identifier and an access level indicator for the peripheral device. The access level indicator may designate a subset of the plurality of features of the vehicle application for use by the peripheral device. The telematics unit may be configured to receive an access request from the peripheral device at the vehicle, and selectively permit the peripheral device to access the subset of the plurality of features of the vehicle application based upon a comparison of the identifier with an identity of the peripheral device. Accordingly, access by the peripheral device may be denied unless the identity of the peripheral device matches the identifier.

In at least some exemplary illustrations, the token includes a defined duration. The telematics unit may, in such approaches, be configured to selectively permit the peripheral device to access the subset of the plurality of features of the vehicle application based upon the defined duration, and restrict access by the peripheral device after an expiration of the defined duration.

In at least some examples, the token includes a token format indicator, which may include one of an alphabetic indicator, a numeric indicator, alpha-numeric indicator, and a voice command indicator. The telematics unit, in these examples, may configured to selectively permit the peripheral device to access the subset of the plurality of features of the vehicle application based upon a token input matching the format indicator being received.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the exemplary methods disclosed herein;

FIG. 2 is a block diagram depicting an embodiment of a peripheral device is capable of utilizing the exemplary methods disclosed herein in connection with a vehicle; and

FIG. 3 is a process flow diagram illustrating exemplary methods of allowing access to vehicle functions or applications using a peripheral device.

### DETAILED DESCRIPTION OF THE ILLUSTRATED EMBODIMENT(S)

Exemplary illustrations are described herein of a method and system for allowing secure access to a vehicle system using a peripheral device, such as smartwatches or other wearable devices. As will be described further below, a primary device such as a smartphone or computer may generally provide a token to the peripheral device, which the peripheral device may in turn use to gain access to the vehicle. Accordingly, the presence of the primary device is not required for the peripheral device to connect to the vehicle.

### Communications System

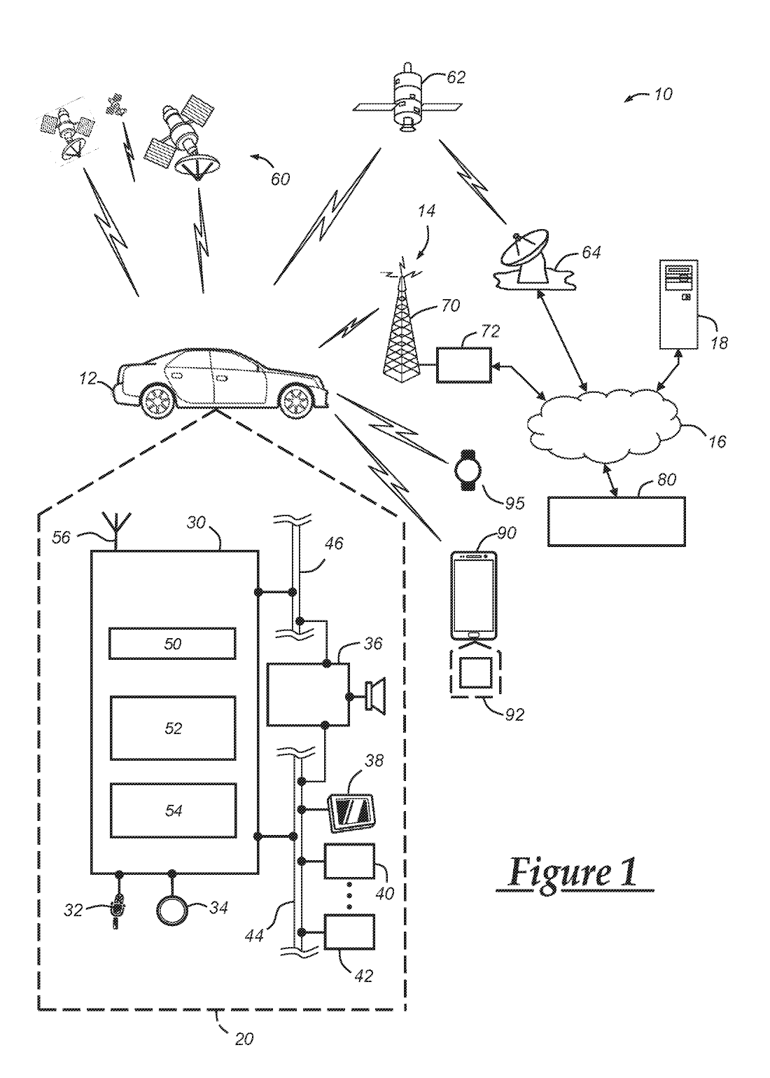

With reference to FIG. 1, there is shown an operating environment that comprises a mobile vehicle communications system 10 and that can be used to implement the methods disclosed herein. Communications system 10 generally includes a vehicle 12, one or more wireless carrier systems 14, a land communications network 16, a computer 18, a remote facility 80, a mobile device 90, and a peripheral device 95. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed methods as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 20 are shown generally in FIG. 1 and include a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with remote facility 80, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art, or via other wireless communication methods, e.g., SMS/text messages. For combined services that involve both voice communication (e.g., with a live advisor or voice response unit at the remote facility 80) and data communication (e.g., to provide GPS location data or vehicle diagnostic data to the remote facility 80), the system can utilize a single call over a voice channel and switch as needed between voice and data transmission over the voice channel, and this can be done using techniques known to those skilled in the art.

According to one embodiment, telematics unit 30 utilizes cellular communication according to GSM, CDMA, or LTE standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as LTE, EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, including short range wireless communication (SRWC) such as any of the IEEE 802.11 protocols, WiMAX, ZigBee™, Wi-Fi direct, Bluetooth, or near field communication (NFC). When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to remote facility 80 or other remote computer system, such as computer 18, for other purposes, such as fleet management. Also, new or updated map data can be downloaded to the GPS module 40 from the remote facility 80 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 20 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the remote facility 80. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to remote facility 80. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, remote facility 80 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or remote facility 80, or both. A computer 18 can also be used for providing Internet connectivity such as DNS services or as a network address server that uses DHCP or other suitable protocol to assign an IP address to the vehicle 12.

Remote facility 80 is designed to provide the vehicle electronics 20 with a number of different system back-end functions. The remote facility 80 may include one or more switches, servers, databases, live advisors, as well as an automated voice response system (VRS), all of which are known in the art. Remote facility 80 may include any or all of these various components and, preferably, each of the various components are coupled to one another via a wired or wireless local area network. Remote facility 80 may receive and transmit data via a modem connected to land network 16. A database at the remote facility can store account information such as subscriber authentication information, vehicle identifiers, profile records, behavioral patterns, and other pertinent subscriber information. Data transmissions may also be conducted by wireless systems, such as 882.11x, GPRS, and the like. Although the illustrated embodiment has been described as it would be used in conjunction with a manned remote facility 80 using a live advisor, it will be appreciated that the remote facility can instead utilize a VRS as an automated advisor or, a combination of the VRS and the live advisor can be used.

Mobile device 90 is a non-vehicle device, meaning that it is not a part of vehicle 12 or vehicle electronics 20. The mobile device includes: hardware, software, and/or firmware enabling cellular telecommunications and/or short range wireless communication (SRWC), as well as other wireless device functions and applications. The hardware of mobile device 90 comprises a processor and memory for storing the software, firmware, etc. This memory may include volatile RAM or other temporary powered memory, as well as a non-transitory computer readable medium that stores some or all of the software needed to carry out the various external device functions discussed herein. The mobile device processor and software stored in the memory enable various software applications, which may be preinstalled or installed by the user (or manufacturer) (e.g., having a software application or graphical user interface (GUI)). This may include an application 92 that can allow a vehicle user to communicate with vehicle 12 and/or to control various aspects or functions of the vehicle—e.g., among other things, allowing the user to remotely lock/unlock vehicle doors, turn the vehicle ignition on or off, check the vehicle tire pressures, fuel level, oil life, etc. The application may also be used to enable the user of device 90 to view information pertaining to the vehicle (e.g., the current location of the vehicle, whether the vehicle is locked or unlocked) and/or pertaining to an account associated with the user or vehicle. Wireless device 90 is shown as a smartphone having cellular telephone capabilities. In other embodiments, device 90 may be a tablet, laptop computer, or any other suitable device. In addition, application 92 may also allow the user to connect with the remote facility 80 or call center advisors at any time.

One or more peripheral devices 95, e.g., wearable devices such as a smartwatch, may be associated with the mobile device 90. The mobile device 90 may be a primary device with respect to the vehicle 12, such that it controls access by the peripheral device 95 to the vehicle 12 or functions thereof, as will be described further below. The peripheral device 95 may communicate with or be linked to mobile device 90 by way of a Bluetooth connection or WiFi connection, merely as examples. Similarly, the peripheral device 95 may communicate directly with vehicle 12, including but not limited to a Bluetooth or WiFi link. The peripheral device 95 may provide support for at least part of the functions or commands available through the application 92 by way of mobile device 90. The peripheral device 95 may have a user interface such as a touchscreen, microphone, keypad, or any other interface that is convenient. The peripheral device 95 may in some cases be relatively small, permitting the peripheral device to be worn, e.g., as a wristwatch, pendant, or the like.

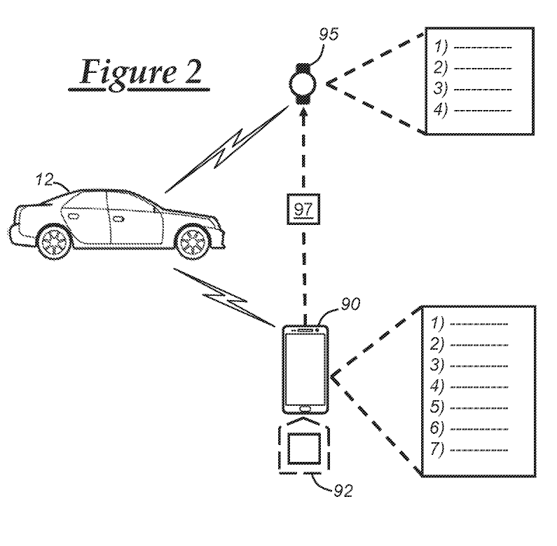

Turning now to FIG. 2, examples of peripheral devices 95 are described in further detail. As noted above, in some examples a user interface associated with peripheral device 95 may be relatively limited as compared with mobile device 90. For example, a relatively smaller/lighter size of the peripheral device 95 may permit a more limited user interface, e.g., a smaller touchscreen, more limited processing power, etc. As a result, peripheral device 95 may generally offer a relatively limited set of commands or inputs as compared with mobile device 90. In one example, voice commands or relatively simple text/numerical inputs (only) are permitted directly to the peripheral device 95.

In the example illustrated, the mobile device 90 may provide a token 97 to peripheral device 95. Token 97 may generally permit access by peripheral device 95 to a set of commands or instructions to vehicle 12, e.g., including commands or instructions which mobile device 90 may also send to the vehicle 12 by way of application 92. The peripheral device 95 may thereby send any one of a set of commands or instructions directly to the vehicle 12, even in the absence of the mobile device 90. In the example shown, the mobile device 90 is capable of a set of seven (7) different functions with respect to the vehicle. The token 97 generated by the mobile device 90, however, only permits the peripheral device 95 to have access to a subset of the commands, in this case only four (4) of the functions. It should be readily understood that any number of functions or commands may be permitted, and that the particular number of functions provided in this example, or even the scale thereof, is not limiting. Additionally, while the mobile device 90 may offer the most convenient manner of generating a token 97, the token 97 may be generated by other computing devices or types thereof, or even by computing systems of the vehicle 12 itself.

The mobile device 90 may set permissions or otherwise control access by the peripheral device 95 to commands or instructions for vehicle 12. In one example, the mobile device 90 includes an identification of the peripheral device 95 in the token, along with an access level for the peripheral device 95. Upon initially attempting to send a vehicle command or otherwise access vehicle functions by way of the peripheral device 95, the peripheral device may provide the token to the vehicle 12. The vehicle 12 may be provided with a copy of the token generated by the mobile device 90, or otherwise have a basis for determining the authenticity of the token 97 received from the peripheral device 95. For example, the telematics unit 30 may receive a copy of the token 97 from the mobile device 90. Additionally, while the mobile device 90 is generally described herein as generating token 97, the vehicle 12 or components thereof such as the telematics unit 30 may in other examples generate the token 97 and provide to the mobile device 90.

Upon determining that the peripheral device 95 is permitted access, the vehicle 12 may then permit access to the subset of vehicle functions as indicated in the token 97. This determination may also include the user entering a numeric, alphabetic, alphanumeric, voice command, or any other passcode, password, or the like along with the token to the vehicle 12. The format of the token 97, as well as any needed passwords, passcodes, or the like may generally be optimized for the relatively limited user interface of the peripheral device 95. Merely as one example, a voice activation or 4-digit numerical entry (e.g., a personal identification number or PIN) may be employed where the peripheral does not have a useful keyboard for entering longer passwords.

The token 97 may subsequently reside on the peripheral device 95, e.g., by storage on a computer-readable medium, to facilitate subsequent access to vehicle 12 commands.

The mobile device 90 may determine an access level for the peripheral device 95, as noted above. In one example, the mobile device 90 determines a time limit or limited duration for the peripheral device 95 access. Merely as one illustration, the mobile device 90 may set a limited duration of six months for the peripheral device 95 to have access to the vehicle 12, after which access by the peripheral device is cut off or otherwise denied upon an attempt from the peripheral device 95.

Accordingly, the mobile device 90 or other master device with respect to the peripheral device 95 may generally maintain control over the creation of the token including governing the nature of the token (alphanumeric, numeric, alphabetic, or voice, for example), a duration of the token, a type of device that the token targets (smartwatch, etc.), and the functionality that the peripheral device 95 would access (commands, functions, notifications, reservations, etc.).

The mobile device 90 thereby allows for the generation of token 97 for connecting peripheral device(s) 95 through application 92. The mobile device 90 may also revoke the token 97, or restrict functions to which the peripheral device 95 has access. A user may thereby share and control access among their devices (i.e., mobile device 90 and peripheral device 95), to segregate access to features across the devices 90, 95.

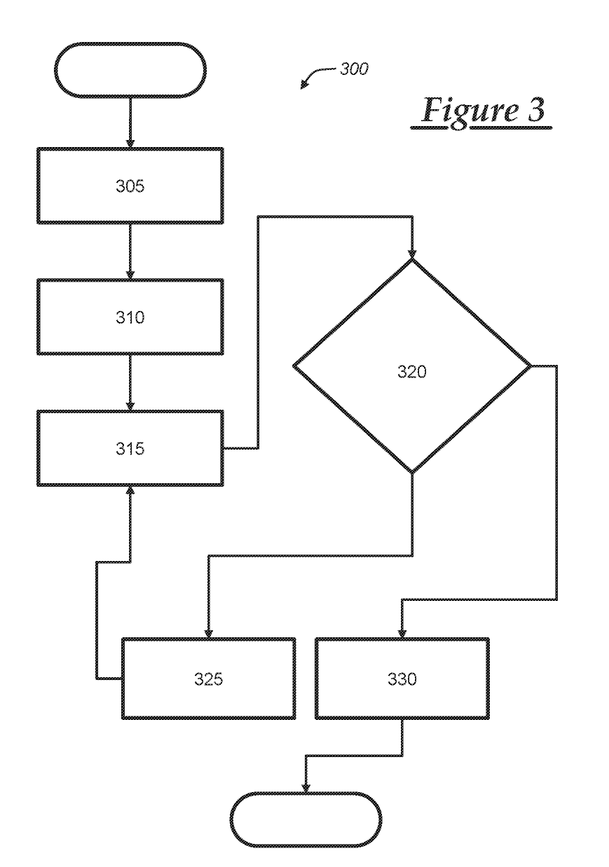

Turning now to FIG. 3, a process flow diagram illustrating example methods of permitting access to vehicle functions or commands by way of a peripheral device are illustrated. Process 300 may begin at block 305, where a peripheral device access request is received. In one example, the mobile device 90 sends a request for the peripheral device 95 to the vehicle 12. Process 300 may then proceed to block 310.

At block 310, a token for the peripheral device may be generated in response to the peripheral device access request. For example, as described above the mobile device 90 may send a token 97 to peripheral device 95. The token 97 may include at least an identifier, e.g., of the peripheral device 95 or type of peripheral device 95. The token 97 may further include an access level indicator for the peripheral device 95, including only a subset of the f features of the vehicle application which the mobile device 90 is permitted access. The token 97 may also include a token format indicator including one of an alphabetic indicator, a numeric indicator, alpha-numeric indicator, and a voice command indicator. Additionally, the token 97 may include a defined duration, i.e., a limited time period during which the peripheral device 95 is permitted access to the functions/commands associated with vehicle 12.

Proceeding to block 315, an access request is received from the peripheral device 95. For example, the peripheral device 95 may send a request for access to vehicle commands to the telematics unit 30. Process 300 may then proceed to block 320.

At block 320, process 300 queries whether access by the peripheral device 95 is permitted. In one example, the token 97 is compared with a copy thereof stored on the vehicle 12, e.g., at the telematics unit 30. In another example, the user of the peripheral device 95 provides a passcode, password, alpha-numeric entry, voice command, or the like. The user input may be compared with that stored on the vehicle 12, as provided by the mobile device 90 initially upon association of the peripheral device 95. Accordingly, access may be selectively restricted based at least upon a comparison of the identifier included in the token with an identity of the peripheral device. In some examples, access by the peripheral device 95 may be denied unless the identity of the peripheral device matches the identifier and a token input, i.e., the user input from the peripheral device 95, matching the format indicator is received. Access may, in addition, be limited to the duration of time indicated in the token 97, such that access only continues until the time limit or duration expires.

If access is permitted, process 300 may proceed to block 325, where the peripheral device 95 is permitted to access the subset of the plurality of features of the vehicle application. Process 300 may then proceed to block 315, upon receipt of another access attempt by a peripheral device.

If access is not permitted at block 320, process 300 may instead proceed to block 330. At block 330, access by the peripheral device 95 is denied. For example, if inappropriate or otherwise unpermitted use is detected, e.g., by the lack of a token being received, a user entry not matching an appropriate passcode/password, or the like, the vehicle 12 may prevent access by the peripheral device 95. Additionally, the vehicle 12 may disconnect the peripheral device, e.g., by way of disconnecting the peripheral device 95 from further communications through an associated Bluetooth or WiFi connection, or the like. Process 300 may then terminate.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of providing access to a peripheral device, comprising:
(a) receiving a peripheral device access request from a primary device for a vehicle application, the primary device configured to access a plurality of features of the vehicle application; and
(b) generating a token for the peripheral device in response to the peripheral device access request, wherein the token includes at least an identifier and an access level indicator for the peripheral device, the access level indicator including only a subset of the plurality of features of the vehicle application.

2. The method of claim 1, further comprising the step of:
(c) receiving an access request from the peripheral device; and
(d) selectively permitting the peripheral device to access the subset of the plurality of features of the vehicle application based upon a comparison of the identifier with an identity of the peripheral device, wherein access by the peripheral device is denied unless the identity of the peripheral device matches the identifier.

3. The method of claim 1, wherein the token includes a defined duration.

4. The method of claim 3, further comprising selectively permitting the peripheral device to access the subset of the plurality of features of the vehicle application based upon the defined duration.

5. The method of claim 4, further comprising restricting access by the peripheral device after an expiration of the defined duration.

6. The method of claim 1, wherein the token includes a token format indicator.

7. The method of claim 6, wherein the token format indicator includes one of an alphabetic indicator, a numeric indicator, alpha-numeric indicator, and a voice command indicator.

8. The method of claim 7, further comprising selectively permitting the peripheral device to access the subset of the plurality of features of the vehicle application based upon a token input matching the format indicator being received.

9. A method of providing access to a peripheral device, comprising:
(a) receiving a peripheral device access request from a primary device for a vehicle application, the primary device configured to access a plurality of features of the vehicle application;
(b) generating a token for the peripheral device in response to the peripheral device access request, wherein the token includes at least an identifier and an access level indicator for the peripheral device, the access level indicator including only a subset of the plurality of features of the vehicle application, the token further including a token format indicator including one of an alphabetic indicator, a numeric indicator, alpha-numeric indicator, and a voice command indicator;
(c) receiving an access request from the peripheral device; and
(d) selectively permitting the peripheral device to access the subset of the plurality of features of the vehicle application based upon a comparison of the identifier with an identity of the peripheral device, wherein access by the peripheral device is denied unless the identity of the peripheral device matches the identifier and a token input matching the format indicator is received.

10. The method of claim 9, wherein the token includes a defined duration.

11. The method of claim 10, further comprising selectively permitting the peripheral device to access the subset of the plurality of features of the vehicle application based upon the defined duration.

12. The method of claim 11, further comprising restricting access by the peripheral device after an expiration of the defined duration.

13. A system for accessing a vehicle function with a peripheral device, comprising:
a server providing an application configured to be stored on a mobile device, the application configured to receive a peripheral device access request from a primary device for a vehicle application, the primary device configured to access a plurality of features of the vehicle application; and
a telematics unit installed to a vehicle, the telematics unit configured to receive a token for the peripheral device at a vehicle, wherein the token includes at least an identifier and an access level indicator for the peripheral device, the access level indicator including only a subset of the plurality of features of the vehicle application, the telematics unit configured to receive an access request from the peripheral device at the vehicle, and selectively permit the peripheral device to access the subset of the plurality of features of the vehicle application based upon a comparison of the identifier with an identity of the peripheral device, wherein access by the peripheral device is denied unless the identity of the peripheral device matches the identifier.

14. The system of claim 13, wherein the token includes a defined duration.

15. The system of claim 13, wherein the telematics unit is configured to selectively permit the peripheral device to access the subset of the plurality of features of the vehicle application based upon the defined duration.

16. The system of claim 15, wherein the telematics unit is configured to restrict access by the peripheral device after an expiration of the defined duration.

17. The system of claim 13, wherein the token includes a token format indicator.

18. The system of claim 17, wherein the token format indicator includes one of an alphabetic indicator, a numeric indicator, alpha-numeric indicator, and a voice command indicator.

19. The system of claim 18, wherein the telematics unit is configured to selectively permit the peripheral device to access the subset of the plurality of features of the vehicle application based upon a token input matching the format indicator being received.
